(19) United States
(12) Patent Application Publication
(10) Pub. No.: US 2003/0110297 A1
(43) Pub. Date: Jun. 12, 2003

(54) Transforming multimedia data for delivery to multiple heterogeneous devices

(76) Inventors: Ali J. Tabatabai, Cupertino, CA (US); Toby Walker, San Jose, CA (US); Mohammed Z. Visharam, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/283,738

(22) Filed: Oct. 29, 2002

Related U.S. Application Data
(60) Provisional application No. 60/340,388, filed on Dec. 12, 2001.

(51) Int. Cl. G06F 15/16

(52) U.S. Cl. 709/246

(57) ABSTRACT

A multimedia presentation is transformed for playback on multiple heterogeneous target devices. A transformation operation is selected based on capabilities of the target device and used to create an adapted version of the multimedia presentation from a source version of the multimedia presentation. The adapted version contains adapted media data corresponding to a source version of media data for the multimedia presentation. In one aspect, the adapted version of the multimedia presentation also includes adapted composition data corresponding to a source version of composition data for the multimedia presentation. In another aspect, the adapted media data is created from a source version of description data for the multimedia presentation.

### RELATED APPLICATION

This application claims the benefit of U.S. Provisional Application No. 60/340,388 filed Dec. 12, 2001, which is incorporated herein by reference.

### FIELD OF THE INVENTION

This invention relates to the manipulation of multimedia data, and more particularly to transforming multimedia data for delivery to multiple heterogeneous target devices.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2001, Sony Electronics, Inc., All Rights Reserved.

### BACKGROUND

With the growing popularity of digital devices such as personal computers, digital cameras, personal digital assistants (PDAs), cellular telephones, scanners and the like, multimedia data formatted according to well known standards is being shared by all members of society, from hobbyists to neophytes to experts. The many standards governing the capturing, storage and transmission of multimedia data are widely accepted by manufactures of digital devices and are increasingly being incorporated into digital devices to allow for the viewing and sharing of multimedia data in multiple formats and versions. On the Internet, the hypertext markup language (HTML) and Synchronized Media Integration Language (SMIL) are common standards for representing multimedia content. HTML is a Standard Generalized Markup Language (SGML) based standard defined by the World Wide Web Consortium (W3C). HTML describes a Web page as a set of media objects, elements or resources, such as images, video, audio, and JAVA® applications, together with a presentation structure. The presentation structure includes information about the intended presentation of the media resources when the HTML web page is displayed in an Internet browser. This includes, for example, information about the layout of the different multimedia elements. HTML uses nested tags to represent the presentation structure. A more recent version of HTML called XHTML is a functionally equivalent version of HTML that is based on XML rather than SGML. SMIL is an XML-based language for integrating different media resources such as images, video, audio, etc. into a single presentation. SMIL contains features that allow for referencing media resources and controlling their presentation including timing and layout, and features for linking to other presentations in order to create hypermedia presentations. SMIL is a composition language which does not define any representations for the media resources or objects used in a presentation. Instead, SMIL defines a set of tags that allow media objects or resources to be integrated together or composed into a single presentation. While some SMIL features exist in HTML, SMIL focuses on the spatial and temporal layout of media resources and provides greater control of interactivity than HTML.

Another standard for representing multimedia content is the ISO/IEC 14496 standard, “Coding of Audio-visual Objects”, defined by the Moving Pictures Experts Group, Version 4 (referred to as MPEG-4 herein) MPEG-4 specifies how to represent units of aural, visual or audiovisual content as media objects, each of which is represented as a single elementary stream. In MPEG-4, media objects are composed together to create audiovisual scenes. An audiovisual scene represents a complex presentation of different multimedia objects in a structured fashion. Within scenes, media objects can be natural, meaning captured from the world, or synthetic, meaning generated with a computer or other device. For example, a scene containing text and an image with an audio background would be described in MPEG-4 with media objects for the text, image, and audio stream, and a scene that describes how to compose the objects. MPEG-4 audiovisual scenes are composed of media objects, organized into a hierarchical tree structure, which is called a scene graph. Primitive media objects such as still images, video, and audio are placed at the leaves of the scene graph. MPEG-4 standardizes representations for many of these primitive media objects, such as video and audio, but is not limited to use with MPEG-4 specified media representations. Each media object contains information that allows the object to be included into audiovisual scenes.

The primitive media objects are found at the bottom of the scene graph as leaves of the tree. More generally, MPEG-4 scene descriptions can place media objects spatially in: two-dimensional (2D) and three dimensional (3D) coordinate systems, apply transforms to change the presentation of the objects (e.g. a spatial transform such as a rotation), group primitive media objects to form compound media objects, and synchronize presentation of objects within a scene. MPEG-4 scene descriptions build on concepts from the Virtual Reality Modeling Language (VRML). The Web 3D Consortium has defined an XML-based representation of VRML scenes, called Extensible 3D (X3D). While MPEG-4 scenes are encoded for transmission in an optimized binary manner, MPEG has also defined an XML-based representation for MPEG-4 scene descriptions, called the Extensible MPEG-4 Textual format (XMT). XMT represents MPEG-4 scene descriptions using an XML-based textual syntax.

XMT can interoperate with SMIL, VRML, and MPEG-4 players. The XMT format can be interpreted and played back directly by an SMIL player and easily converted to the X3D format before being played back by a X3D or VRML player. XMT can also be compiled to an MPEG-4 representation, such as the MPEG-4 file format (called MP4), which can then be played by an MPEG-4 player. XMT contains two different formats: the XMT-A format and the XMT-Ω format. XMT-A is an XML-based version of MPEG-4 content that contains a subset of X3D with extensions to X3D to allow for representing MPEG-4 specific features. XMT-A provides a one-to-one mapping between the MPEG-4 textual and binary formats. XMT-Ω is a high-level version of an MPEG-4 scene based on SMIL.

The ever widening distribution and use of digital multimedia information has led to difficulties in identifying content that is of particular interest to a user. Various organizations have attempted to deal with the problem by providing a description of the content of the multimedia information. This description information can be used to search, filter and/or browse to locate specified content. The Moving Picture Experts Group (MPEG) has promulgated a Multimedia Content Description Interface standard, commonly referred to as MPEG-7 to standardize content descriptions for multimedia information. In contrast to preceding MPEG standards, including MPEG-4, which define how to represent coded multimedia content, MPEG-7 specifies how to describe the multimedia content.

With regard to the description of content, MPEG-7 may be used to describe MPEG-4, SMIL, HTML, VRML and other multimedia content data. MPEG-7 uses a Data Definition Language (DDL) that specifies the language for defining the standard set of description tools and for defining new description tools, and provides a core set of descriptors and description schemes. The DDL definitions for a set of descriptors and description schemes are organized into “schemas” for different classes of content. The DDL definition for each descriptor in a schema specifies the syntax and semantics of the corresponding feature. The DDL definition for each description scheme in a schema specifies the structure and semantics of the relationships among its children components, the descriptors and description schemes. The format of the MPEG-7 DDL is based on XML and XML Schema standards in which the descriptors, description schemes, semantics, syntax, and structures are represented with XML elements and XML attributes.

### SUMMARY OF THE INVENTION

A multimedia presentation is transformed for playback on multiple heterogeneous target devices. A transformation operation is selected based on capabilities of the target device and used to create an adapted version of the multimedia presentation from a source version of the multimedia presentation. The adapted version contains adapted media data corresponding to a source version of media data for the multimedia presentation. In one aspect, the adapted version of the multimedia presentation also includes adapted composition data corresponding to a source version of composition data for the multimedia presentation. In another aspect, the adapted media data is created from a source version of description data for the multimedia presentation.

### BRIEF DESCRIPTION OF THE DRAWINGS

The novel features of the invention will become apparent upon reading the following detailed description and upon reference to the drawings, in which:

FIG. 1 illustrates a conceptual view of a transformation method described herein.

FIG. 2A illustrates a flow of actions taken according to an embodiment of a transformation method described herein.

FIG. 2B illustrates a flow of actions taken according to an embodiment of a transformation method described herein.

FIG. 3 illustrates an example of an embodiment of the adaptation process according to the methods described herein.

FIG. 4 illustrates a specific example of the adaptation transformation methods described herein.

FIG. 5A illustrates example source multimedia presentation data.

FIG. 5B illustrates example target multimedia presentation data.

FIGS. 6A, 6B and 6C illustrate example transformation rules.

FIG. 7 illustrates an environment in which an embodiment of the transforming and adapting methods described herein may be implemented.

### DETAILED DESCRIPTION

The transforming described herein allows for transforming a multimedia presentation for delivery to multiple heterogeneous devices. A multimedia presentation may include media data, composition data and description data. In one embodiment, the transforming described herein adapts the media data for a source version, and optionally the composition data, for the multimedia presentation so that the multimedia presentation may be played on a target device or a class of target devices. In yet another embodiment, a source multimedia presentation only includes description data from which the adapted media data, and optionally the composition data, is derived.

Data defined for representing images, audio, and video content, such as the well known GIF and JPEG formats for images, the MP3 and WAV formats for audio, and MPEG-1 and MPEG-2 for video, as well as other similar formats are referred to herein as media data, in general, and as media objects for single instances of an image, video, or video data. Other standards specify a format for languages that define how to compose media objects in space and time to form a single coherent multimedia presentation. These standards, such as the Moving Picture Experts Group MPEG-4 (MPEG-4) standard, the World Wide Web Consortium (W3C) Synchronized Media Integration Language (SMIL), the Virtual Reality Modeling Language (VRML), Extensible 3D (X3D), the Hypertext Markup Language (HTML), and other similar standards, are referred to herein as composition standards, and instructions incorporating these standard are referred to as composition data. Composition data specifies spatial and temporal layout and synchronization of media objects. Composition data along with all associated media data referenced by composition data is referred to herein as multimedia presentation data; and an instance of multimedia presentation data is referred to as a multimedia presentation. The format for composition data may be selected independent of the format for media data as composition data formats are media data format independent. Other standards, such as MPEG-7 (formally titled Multimedia Content Description Interface standard), specify a format for describing multimedia content. The data encompassed by the MPEG-7 standard is often referred to as metadata, which is data that describes other data. Data known as metadata and defined by MPEG-7 and other standards are referred to herein as description data. Description data may be combined with the media data and the composition data in a multimedia presentation. In various embodiments, the media data, composition data, and description data which comprise the multimedia presentation data, as well as the multimedia presentation data itself, may be represented in other well known formats.

The transforming and adapting described herein provide for automatically or semi-automatically adapting or transforming a source multimedia presentation including one or more of media data, composition data, and description data for delivery to and presentation on multiple heterogeneous target devices. The adapting is achieved by applying a transformation process that operates on structured representations of the media data, composition data, and description data, such as XML. This adapting process may be implemented on structured composition data representations such as MPEG-4, XMT, SMIL, HTML, and VRML X3D. The description data may be represented according to the MPEG-7 standard. The adapting process may be achieved via a set of rewriting or transformation rules that specify how the composition data, media data, and description data for a multimedia presentation should be transformed for presentation on target devices. These rules may use the source media data, source composition data, and/or source description data as well as user preference or device capability information to determine how to carry out the adaptation process.

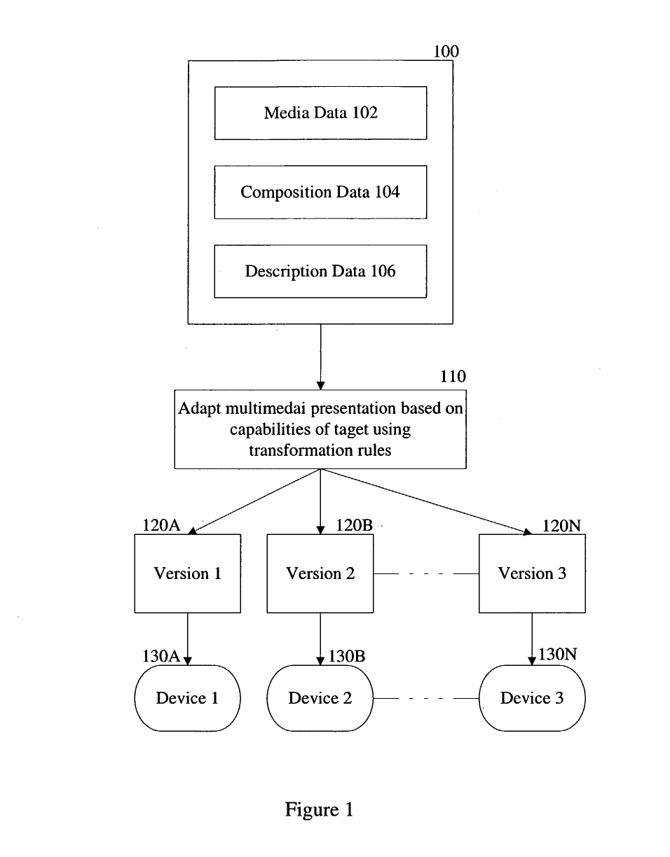

FIG. 1 illustrates a conceptual view of a transformation method described herein. In one embodiment, multimedia presentation 100 may include media data 102, composition data 104, and description data 106. The multimedia data 100 is processed by transformation engine 110, which adapts multimedia presentations, including media data, composition data and description data, based on the capabilities of target devices by referring to transformation rules for each model, type or class of target device. In one embodiment, the various rules for adapting to a particular device may be incorporated as plug-in modules within the transformation engine. Adapted versions of the source multimedia presentation may be delivered to various target devices. For example, a first version 120A may be delivered to first device 130A, a second version 120B may be delivered to a second device 130B, and so on through version N 120N which may be delivered to device N 130N.

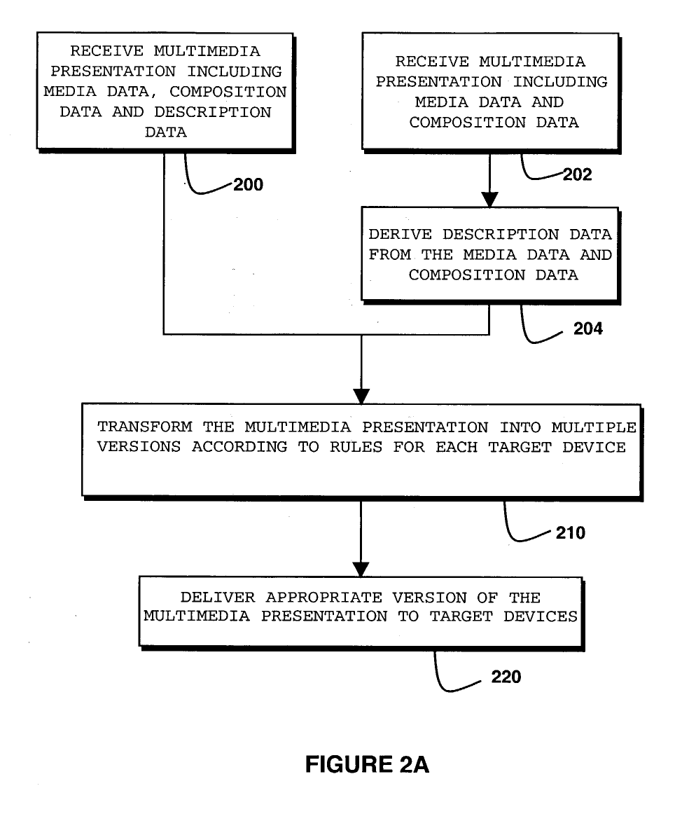

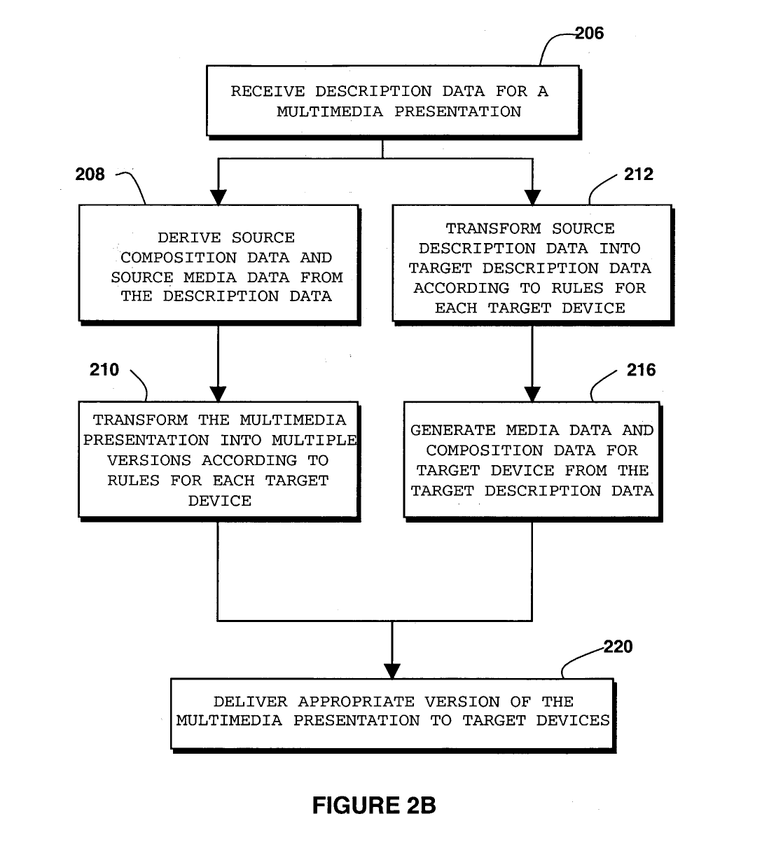

FIG. 2A illustrates a flow of actions taken according to an embodiment of a transformation method described herein. The flow of actions corresponds to the actions taken by transformation engine 110 described above regarding FIG. 1. It will be appreciated that that more or fewer processes may be incorporated into the method illustrated in FIG. 2A, as well as other methods and processes described herein, without departing from the scope of the invention, and that no particular order is implied by the arrangement of blocks shown and described herein. In one embodiment, a multimedia presentation that includes media data, composition data and description data is received, as shown in block 200. In another embodiment, a multimedia presentation that includes media data and composition data may be received as shown in block 202. In this embodiment, description data may be derived from the media data and composition data as shown in block 204. Derivation of description data from the media data may be achieved according to the methods described in U.S. patent application Ser. No. 10/114,891 titled “Transcoding Between Content Data and Description Data” (the “'891 Application”). The multimedia presentation, including media data, composition data and description data, is transformed into multiple versions according to rules for each target device or generic class of target devices, as shown in block 210. More specifically, the multimedia presentation is transformed into multiple target versions based on the features and capabilities of the devices to which the multimedia data will be delivered, according to rules which define the adaptation needed for each target device. In this way, the target versions are tailored to the capabilities of the target devices. The transformation may also be based on and controlled by user preferences for the transformation system and/or for the target device. An appropriate version of the adapted multimedia presentation is delivered to target devices, as shown in block 220. This delivery may occur automatically, such as by subscription of a target device, or may be achieved in response to a specific delivery request from a target device.

FIG. 2B illustrates a flow of actions taken according to an embodiment of a transformation method described herein. In this embodiment, the transformation process receives description data for a multimedia presentation, as shown in block 206. In one embodiment, the transformation process operates directly on source description data. In this embodiment, the, source description data is used to derive source media data and source composition data, as shown in block 208. This transformation is controlled by a set of rules that operate on the source description data. This transformation may be achieved by various methods, including using the methods described in the '891 Application. In this embodiment, the source media data derived from the source description data may be obtained from one or more media sources. The media sources may be local or may be remote, requiring communication over one or more networks, such as, for example, the Internet. The resulting multimedia presentation is transformed into multiple target versions according to rules for each target device, as shown in block 210, to create target multimedia presentations. The transformation may also be based on and controlled by user preferences for the transformation system and/or for the target device. An appropriate version of the adapted multimedia presentation is delivered to target devices, as shown in block 220.

In another embodiment, the source description may be transformed into target description data according to rules for each target device, as shown in block 212. The target description data describes the media data to be adapted for the target device. Target composition data and target media data for the target device are generated from the target description data, as shown in block 216. This may be achieved by various methods, including using the methods described in the '891 Application. In this embodiment, the target media data generated from the target description data may be obtained from one or more media sources. The media sources may be local or may be remote, requiring communication over one or more networks, such as, for example, the Internet. An appropriate version of the adapted multimedia presentation is delivered to target devices, as shown in block 220.

In one embodiment, the received source multimedia including source description data source, composition data and source media data as well as the derived source description data, derived source media data and derived source composition data are represented as an XML-based representation such as SMIL or the Extensible MPEG-4 Textual format known as XMT-Ω, which is a representation of MPEG-4 in XML and is similar to SMIL. The transformation methods described may also be applied to MPEG-4 data stored in other binary forms by transforming it to an XML-based representation like XMT using well known methods, such as those disclosed in the MPEG-4 reference software for XMT. Both composition data and description data may be represented as XML documents. Therefore, the adapting process is a transformation from one XML document to another XML document. As such, in one embodiment, the adapting is implemented as a set of transformation rules that operate on the XML data structure that represents the source description data, media data and composition data using, for example, SMIL/XMT data for composition data and MPEG-7 for description data. The rules to transform the multimedia presentation may be written in an extended form of the extensible stylesheet language (XSL) and the extensible stylesheet language transformations (XSLT). That is, one or more XSLT files may control how the multimedia data is transformed for delivery and presentation on destination devices.

In one embodiment, the transformation process includes applying a set of transformation rules to the description data for a multimedia presentation. The transformation rules may be thought of as rewrite rules. Each rule may specify a condition and action pair. The condition part of each rule defines when the rule will be applied and is defined with respect. to a part of the structured representation of the description data and the representation of the capabilities of the target device. The action part of the rule constructs a part of the target description data based on the source description data. The process of transformation is carried on by repeatedly applying rules whose condition matches until no more such rules match the evolving description data, or until a stopping condition is met. The stopping condition occurs when the target description data meets the requirements of a description of a multimedia presentation that is presentable on the target device. In various embodiments, the process of rule application may be deterministic or non-deterministic.

In some embodiments, a cost may be associated with each rule so that a search algorithm may be applied to find an optimal or nearly optimal sequence of rules that produce the lowest cost transformation of the source description using search and optimization techniques well known to those versed in the art. A cost for a rule may represent how well the target data meets the requirements of the target device for which the presentation is being adapted.

When the description data is represented in XML or can be mapped into an equivalent XML-based representation, the transformation can be implemented using rules written in XSLT and implemented by an XSLT engine using techniques well known to those versed in the art. Once the target description data has been created by the transformation process, the methods described in the '891 Application may be applied to transcode the description data into the target media data and target composition data.

The target media data is generated from the source media data by applying media adaptations that map the source media data into the target media described in the target description data. For example, when the image size in the target description specifies a different image size, a corresponding resizing operations is applied to the image.

In another embodiment, the transformation process transforms both the media data and composition data using rules controlled by the description data. The description data used in this process may have been furnished externally or may be generated automatically. In this embodiment, the transformation process consists of two kinds of transformations working together to adapt the multimedia presentation: media transformations, which transform media data; and composition transformations, which transform the structure of the composition data. The transformation process applies a sequence of media and/or composition transformations.

Media transformations may include low-level operations implemented using well known signal processing algorithms, such as operations that perform format transformations, for example, changing an image from JPEG to GIF format, or operations that change the low-level properties of the media, for example, altering the sample rate of audio data and resizing an image. Other media transformations may transform media from one format to another, such as an operation that translates video into a sequence of images representing a summary of the media, such as, for example, key frames. The transformation process does not depend on the details of a source data authoring or creation implementation but requires knowledge of the target media format. In one embodiment, atomic media transformations are implemented as plug-in components that export a standard interface describing the transformation implemented by the plug-in component.

Composition transformations operate on structured data representations of the composition data. Such representations may be XML-based when using composition data formats like SMIL, XMT, and the like. Composition transformations may also be implemented by translating other representations into an equivalent XML-based format. Similar techniques as described for transforming description data may be applied to implement composition transformations.

In one embodiment of the transformation methods described herein, a rule set determines and controls the joint adaptation of the media and the composition data. In this embodiment, each rule specifies a condition and action pair. The condition part of each rule defines when the rule will be applied to the composition/media data and is defined with respect to a part of the structured representation of the composition data and the associated description data for the composition data and media data referenced therein. The action part applies media and composition adaptations to generate the target composition data structure and the media data necessary for the target multimedia presentation. The transformation process includes repeatedly applying rules having matching conditions until no more such rules apply or a stopping condition occurs. A stopping condition occurs when the target composition and media data meet the requirements of a multimedia presentation that is presentable on a target device. The process of rule application may be deterministic or non-deterministic.

In some embodiments, a cost may be associated with each rule so that a search algorithm may be applied to find an optimal or nearly optimal sequence of rules that produce the lowest cost transformation of the source data using search and optimization techniques well known to those versed in the art. Such a cost may reflect how well the resulting output target data meets the requirements of the target device for which the presentation is being adapted.

When the composition data is represented in XML or may be mapped into an equivalent XML-based representation, the transformation may be implemented using rules written in XSLT and implemented by an XSLT engine using techniques well known to those versed in the art.

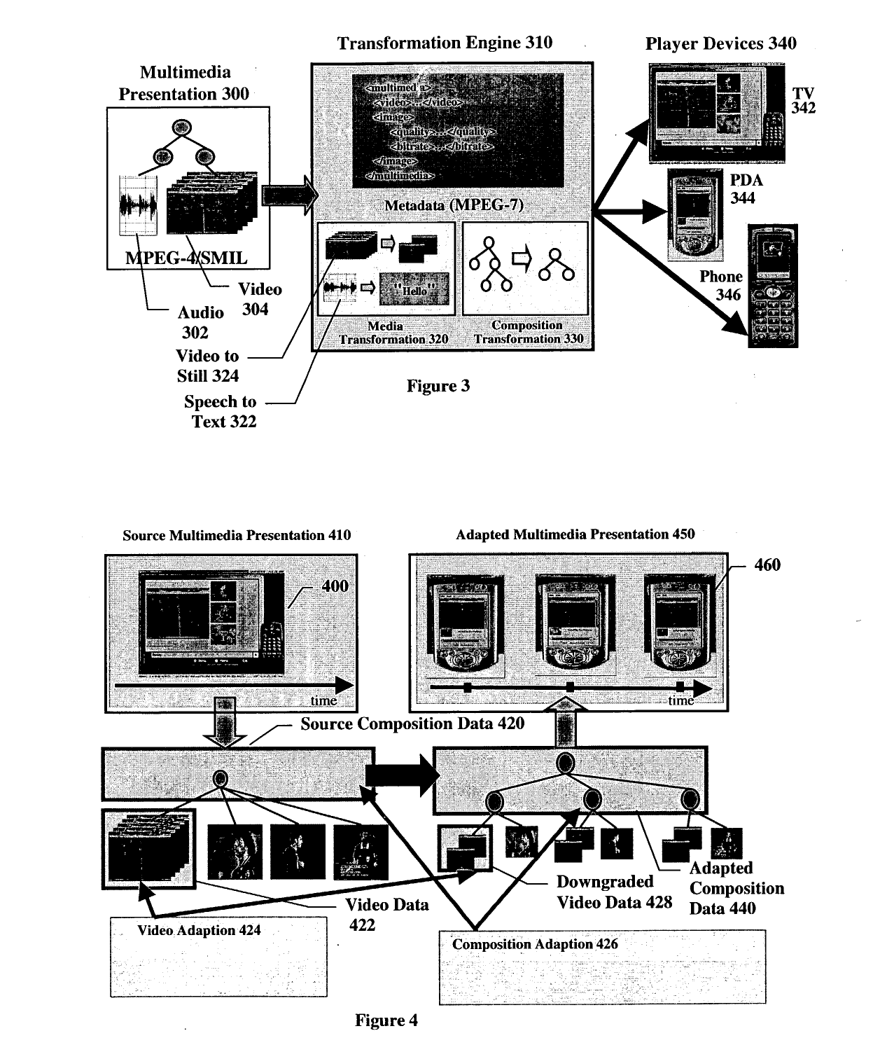

FIG. 3 illustrates an example of an embodiment of the adaptation process according to the methods described herein. Multimedia presentation 300 may include media data in the form of audio data 302 and video data 304 arranged according to composition data in MPEG-4/SMIL tree structured format. In one embodiment, the audio data may be in MP3 or other well-known audio format and the video data may be in MPEG-4 video or other well known video content data format. In addition to the media data, description data may be included with the multimedia presentation. Transformation engine 310 receives multimedia data and adapts it so that it may be delivered and played or otherwise presented on various target player devices 340. The adaptation performed by transformation engine 310 may include media transformations such as transforming the video data to a series of still frames, as shown by element 324, when the player device is not capable of playing video data. The adaptation may also include transforming speech to text, as shown by element 322. So that the adapted media data may be appropriately displayed on target devices, composition transformation is performed, as shown by element 330. That is, composition data in a well known format known such as SMIL or HTML and the like may be provided to target devices along with the adapted media data so that the adapted media data is presented in a manner which makes sense according to the particular adaptation. For example, when the multimedia content in the form of a combined audio-video segment is adapted to be a series of still frames and text, the presentation of the still frames must be coordinated with the text so that the resulting presentation is enjoyed by a viewer in a comprehensible manner. Player devices 340 may include television 342, PDA 344, and cellular telephone 346. In one embodiment, a television may receive an adapted version of the multimedia data that conforms to the National Television Standards Committee (NTSC), Phase Alternating Line (PAL), Digital Television (DTV) and other similar standards, while,the versions provided to a PDA and a cellular telephone may be downgraded versions of the source multimedia data which reduce the resolution of frames of images, reduce the frame rate, reduce the number of colors, etc.

In addition, the downgraded version may be adapted to reduce the size of the multimedia data to fit in bandwidth constraints of the medium through which the adapted version of the multimedia data will be transmitted or otherwise delivered to a target device. For example, data to be transmitted over a cellular telephone system must be smaller than the data that may be transmitted via a Bluetooth or IEEE 802.11 wireless system due to the smaller bandwidth of the cellular telephone system. Similarly, different adapted versions may be created for each class of target device that adheres to the IEEE 802.11, 802.11a, 802.11b and 802.11g standards. In this way, the fidelity or quality of the adapted multimedia presentation may be contoured or customized to match the capabilities and properties of the communication stream of target devices, as well as the resolution, color and other characteristics and capabilities of the target device.

FIG. 4 illustrates a specific example of the adaptation transformation methods described herein. In this example, source multimedia presentation 410 may be an audio-video feed of a soccer match such as that shown on television 400. This multimedia presentation may include media data, description data and composition data. Source composition data 420 may be adapted according to composition adaptation methods 426 to create or derive adapted composition data 440, and the media data in the form of video data 422 may be adapted via video adaptation methods 424. More specifically, if the video data is to be adapted for presentation on a PDA, the source video data of 1200 by 1600 DPI at 40 frames per second may be adapted or downgraded to 20 by 30 DPI at 15 frames per second, as shown by downgraded video data 428. If the adaptation were to a more limited target device such as a cellular telephone, the video data may be adapted into a sequence of still frames which provide a representation of the soccer match at various points in time. Similarly, if there is a voice track or channel associated with the multimedia source presentation, the voice may be adapted into text. In this situation, the composition adaptation must take into consideration the coordination and alignment of the text with the still images for a comprehensible presentation on a cellular telephone. The end result is adapted or target multimedia presentation 450 shown on target PDA 460. The adaptations described in this paragraph may be referred to as modality adaptations or transformations. The modality adaptations include changing media data from a source modality to a target modality, such as for example, from video to still graphics, from a first language to a second language, and from speech to text.

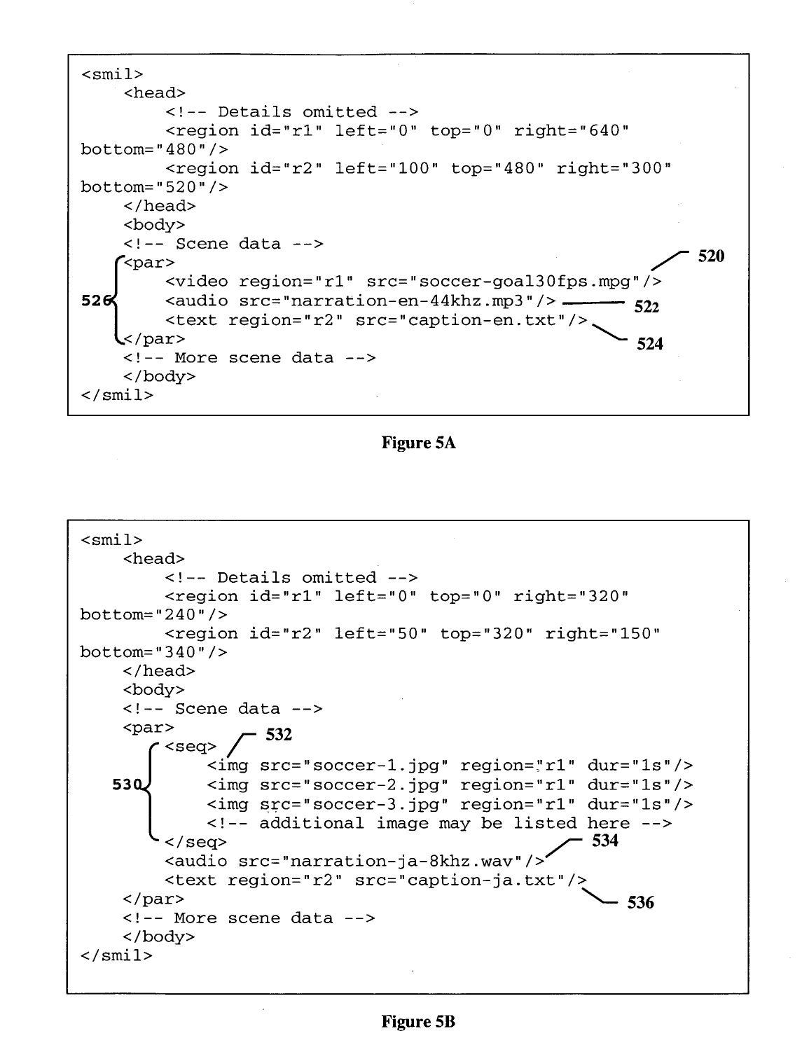

FIG. 5A illustrates example source multimedia presentation data, while FIG. 5B illustrates example target multimedia presentation data. The example multimedia presentation data in FIGS. 5A and 5B show composition data in SMIL. In these examples, the composition data have been simplified for explanatory purposes. The source multimedia presentation is for a high-capability device, such as a personal computer, with a language of English. The target multimedia presentation is the result of adapting the source multimedia presentation to a lower-capability device, such as PDA and changing the language from English to Japanese. More specifically, FIG. 5A shows an excerpt of SMIL composition data for a high capability device that can display high-quality video and audio. The excerpt is part of a multimedia summary of a soccer game similar to that illustrated in FIG. 4. FIG. 5B shows the same excerpt adapted for a lower-capability device that cannot display video and can only play low quality audio.

The source composition data shown in FIG. 5A has three media objects that are presented concurrently, as indicated by the <par> element 526, which designates parallel presentation. The first media object, indicated by the <video> tag 520, is an MPEG-2 video, from the data source file “soccer-goal-30fps.mpg” displayed in region “r1” at a resolution of 640×480 pixels at 30 frames per second. The second media object, indicated by the <audio> tag 522, is a high-quality English language MP3 audio clip at 44 KHz from the source file “narration-en-44 khz.mp3”. The third media object 524 is a text caption from the source “caption-en.txt” in English.

To adapt the source multimedia presentation, both the source composition data and source media data are transformed to yield the target multimedia presentation shown in FIG. 5B. Because the lower capability target device does not support video playback, the first adaptation performed transformed the source video data into a set of key frames which were selected to summarize the video's content. This part of the multimedia presentation is represented in the composition data using the “seq” and “img” tags 530 and 532 shown in FIG. 5B. In this example, the audio is also adapted such that both the audio signal and the audio content are adapted. Because the lower quality device only supports low fidelity audio playback, the format of the source audio is adapted from MP3 to WAV and downsampled from 44 KHz to 8 KHz as shown by WAV audio object 534. In addition, the language of both the audio object and text object are adapted from the source language of English to the target language of Japanese as shown by text object 536.

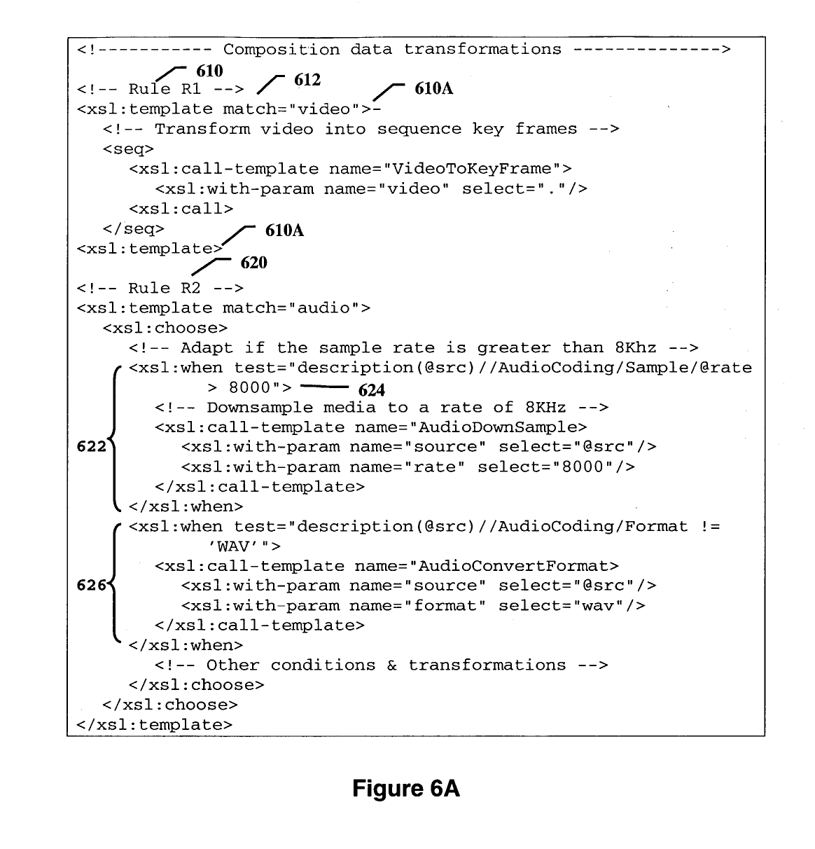

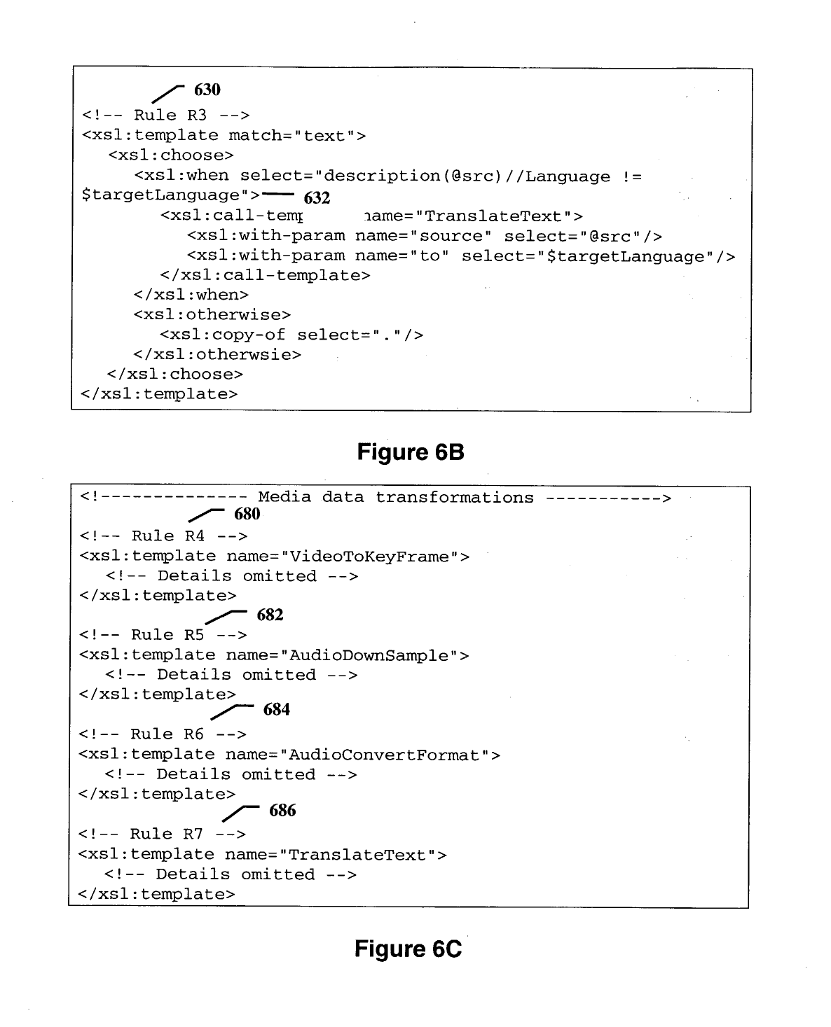

FIGS. 6A, 6B and 6C illustrate example transformation rules. The rules provide examples of transformation rules that can be used to realize the transformation from source multimedia presentation data shown in FIG. 5A to target multimedia presentation data shown in FIG. 5B. The rules shown in FIGS. 6A, 6B and 6C are represented in a language similar to XSLT. Each rule, referred to as a template in XSLT, expresses a transformation (that is, a rewriting) rule and is indicated by the <xsl:template>. . . </xsl:template> syntax as shown by, for example, 610A and 610B. The condition part of a rule indicated by the “match” attribute 612 designates the kind or class of presentation data to which the rule applies. The body of each rule, contained within “xsl:template” tags, such as tags 610A and 610B of Rule R1 610, includes instructions for forming the result of transforming the part of the SMIL multimedia that matches the condition of the rule.

In FIGS. 6A and 6B, rules R1 through R3 transform composition data and are referred to as composition data transformation rules, and in FIG. 6B, rules R4 through R7 transform media data and are referred to as media data transformation rules. Example Rule R1 610 adapts the composition of video objects to the capabilities of a target device by invoking the VideoToKeyFrame media transformation rule, Rule R4 680 shown in FIG. 6C. While details of the implementation of VideoToKeyFrame media transformation rule are not shown, this transformation rule creates a sequence of images from the video that summarize the video by selecting a group of key frames from the video. Rule R1 matches the <video> element 520 contained in FIG. 5A and transforms it to the <seq> . . . </seq> data 530 in FIG. 5B.

Example Rule R2 620 adapts the composition of audio objects in the source SMIL composition data by applying transformations depending on the description data associated with the media source of the audio object. The first condition 622 checks whether the sample rate of the audio data exceeds the 8 KHz maximum sample rate that the target device can support. If the sample rate of the audio data exceeds this, an AudioDownSample transformation rule, such as Rule R5 682 of FIG. 6C, is invoked to transform the audio data by downsampling the audio media data. Example Rule R2 checks the description data which indicates the samples rate as indicated in segment 624 by the condition:

“description(@src)//AudioCoding/Sample/@rate>8000”.

The description ( ) function used in the condition shown in segment 624 returns the MPEG-7 description data associated with a media object specified by a Uniform Resource Locator (URL). A similar test in second condition 626 checks whether the audio data is in WAV format, and, if it is not in WAV format, an AudioConvertFormat rule, such as Rule R6 684 of FIG. 6C, is invoked to transcode the format. Otherwise the audio presentation data is passed through untransformed. Example Rule R2 would apply to the <audio> element 522 shown in FIG. 5A to transform it to the <audio> element 534 in which the media data (indicated by the change in the “src” field's value) is changed from 44 KHz MP3 format to 8 KHz WAV format.

Example Rule R3 transforms the composition of textual media objects in the SMIL composition data. Example Rule R3 630 includes a condition 632 that checks to see whether the language of the text is in a desired language, as specified buy the $targetLanguage variable, which is assumed known from some source, matches that of the text. If the source language does not match the target language, a TranslateText transformation rule, such as Rule R7 686 of FIG. 6C, is invoked to transform the text into the desired target language. This rule may be applied to the <text> element 524 shown in FIG. 5A to translate the language as shown by <text> element 536 in FIG. 5B.

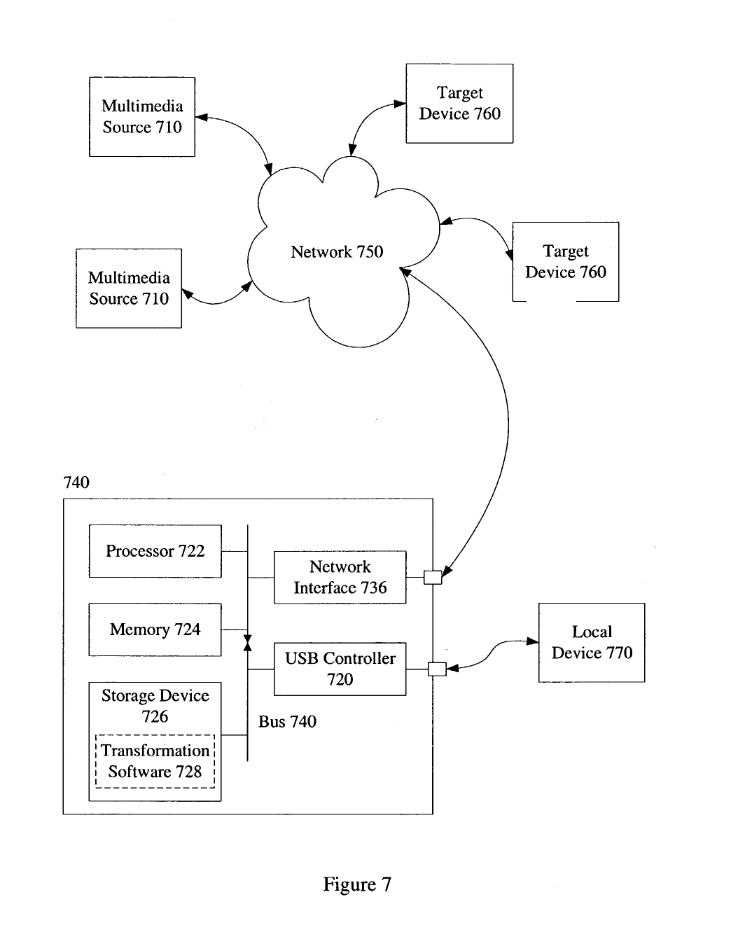

FIG. 7 illustrates an environment in which an embodiment of the transforming and adapting methods described herein may be implemented. The methods disclosed herein may be implemented in software, hardware, and a combination of software and hardware such as firmware. Media data may be generated, authored or otherwise made available by one or more multimedia sources such as, for example, multimedia source 710 to server computer 720. In various embodiments, the media sources may be one or more of a digital television broadcast, a live video feed, a stock ticker, an audio broadcast, and the like communicated over airwaves or broadcast on a wide area network such as the Internet or other similar network 750. In one embodiment, the methods described herein may be implemented on a computer, such as server computer 720. In one embodiment, server computer 720 includes processor 722 and memory 724. In one embodiment, software that executes the various embodiments of the methods described herein may be executed by processor 722. Processor 722 may be any computer processor or microprocessor, such as, for example, and Intel® Pentium® 4 processor available from Intel Corporation of Santa Clara, Calif., and memory 724 may be any random access memory (RAM). Network interface 736 may be an analog modem, a cable modem, a digital modem, a network interface card, and other network interface controllers that allow for communication via a wide area network (WAN) such as network 750, for example, the Internet via a local area network (LAN), via well-known wireless standards, etc.

In one embodiment, computer instructions in the form of software programs may be stored on storage device 726 which may be a hard disk drive. The software that may implement the methods described herein may be referred to, in one embodiment, as transformation software 728. This computer software may be downloaded via network 750 or other WAN or LAN through network interface 736 to server computer 720 and stored in memory 724 and/or storage device 726. In various embodiments, storage device 726 may be any machine readable medium, including magnetic storage devices such as hard disk drives and floppy disk drives, optical storage devices such as compact disk read-only memory (CD-ROM) and readable and writeable compact disk (CD-RW) devices, readable and writeable digital versatile disk (DVD) devices, RAM, read-only memory (ROM), flash memory devices, stick memory devices, electronically erasable programmable read-only memory (EEPROM), and other silicon devices. In various embodiments, one or more machine readable media may be coupled locally, such as storage device 726, or may be accessible via electrical optical, wireless, acoustic, and other means from a remote source, including via a network.

In one embodiment, each of processor 722, memory 724, storage device 726, USB controller 730 and network interface 736 are coupled to bus 740, by which each of these devices may communicate with one another. In various embodiments, two or more buses may be included in server computer 720. In addition, in various embodiments, two or more of each of the components of server computer 720 may be included in server computer 720. It is well known that server computer 720 includes an operating system such as Microsoft® Windows® XP Professional available from Microsoft Corporation of Redmond, Wash.

In one embodiment, server computer 720 may be implemented as two or more computers arranged as a cluster, group, local area network (LAN), subnetwork, or other organization of multiple computers. In addition, when comprised of multiple computers, the server computer group may include routers, hubs, firewalls, and other networking devices. In this embodiment, the group may include multiple specialized servers such as, for example, graphics servers, audio servers, transaction servers, applications servers and the like. In one embodiment, server computer 720 may rely on one or more third parties (not shown) to provide transaction processing, and/or other information and processing assistance over network 750 or via a direct connection.

In one embodiment, a user of a target computing device such as a personal computer, personal digital assistant (PDA), cellular telephone, computing tablet, portable computer, and the like and shown as destination devices 760 may obtain multimedia data originating from a remote source such as multimedia source 710 by communicating over network 750 with server computer 720. In one embodiment, destination device 760 may have a configuration similar to server computer 720. In addition, the target devices include a video display unit and/or an audio output unit which, in various embodiments, allow a user of the target devices to view information such as video, graphics, and/or text, and listen to various qualities of audio, all depending on the capabilities of the video display unit and the audio unit of the target device. Target devices also include user input units such as a keyboard, keypad, touch screen, mouse, pen, and the like.

In one embodiment, server computer 720 may obtain multimedia presentation data and transfer it to local device 770 after transforming and adapting the multimedia presentation's composition, description, and/or media data according to the methods described herein. The local device may be a cellular telephone, PDA, MP3 player, portable video player, portable computer and the like which is capable of receiving transformed multimedia presentation and media data via electrical, optical, wireless, acoustic, and other means according to any well known communications standards, including, for example, Universal Serial Bus (USB) via USB controller 730, IEEE 1394 (more commonly known has I.Link® and Firewire®), Bluetooth™ and the like. The communication between server 720 and local device may support communications protocol such as HTML, IEEE 802.11, W3PP, and/or WAP protocols for mobile devices and other well known communications protocols for requesting multimedia presentation data.

In the foregoing specification, the invention has been described with reference to specific embodiments thereof. It will be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
selecting a transformation operation from a plurality of transformation operations based on capabilities of a target device; and
creating an adapted version of a multimedia presentation for the target device from a source version of the multimedia presentation using the selected transformation operation, the adapted version of the multimedia presentation comprising adapted media data corresponding to a source version of media data for the multimedia presentation.

2. The method of claim 1, wherein creating an adapted version comprises:
transforming a source version of description data for the multimedia presentation into a target version of the description data; and
generating the adapted media data from the target version of the description data.

3. The method of claim 1, wherein creating an adapted version comprises:
deriving the source version of the media data from a source version of description data for the multimedia presentation; and
transforming the source version of the media data into the adapted media data.

4. The method of claim 1, wherein creating an adapted version comprises:
preparing an adapted media object for each of a plurality of media objects in the source version of the media data.

5. The method of claim 1, wherein creating an adapted version comprises:
adapting at least one of a spatial resolution and a temporal resolution if the source version of the media data includes at least one of video data and image data.

6. The method of claim 1, wherein creating an adapted version comprises:
adapting a bit rate of the source version of the media data according to a desired bit rate.

7. The method of claim 6, wherein the desired bit rate is based at least one of user preferences, transmission medium bandwidth, and target device capabilities.

8. The method of claim 1, wherein creating an adapted version comprises:
generating a summarized form of the source version of the media data.

9. The method of claim 1, wherein the adapted version of the multimedia presentation further comprises adapted composition data corresponding to a source version of composition data for the multimedia presentation.

10. The method of claim 9, wherein creating an adapted version comprises:
generating the adapted composition data based on the capabilities of the target device and properties of the adapted media data.

11. The method of claim 9, wherein creating an adapted version comprises:
transforming a source version of description data for the multimedia presentation into a target version of the description data; and
generating the adapted composition data from the target version of the description data.

12. The method of claim 9, wherein creating an adapted version comprises:
deriving the source version of the composition data from a source version of description data for the multimedia presentation; and
transforming the source version of the composition data into the adapted composition data.

13. The method of claim 9, wherein the adapted composition data comprises spatial and temporal layout, and synchronization information for a plurality of media objects in the adapted media data.

14. The method of claim 9, wherein the source version of the multimedia presentation further comprises the source version of the composition data.

15. The method of claim 1, wherein selecting a transformation operation comprises sequencing selected transformation operations to meet optimization criteria.

16. The method of claim 1, wherein the transformation operation is selected according to a set of rules.

17. The method of claim 1, wherein the capabilities of the target device include properties of a medium for delivering the adapted multimedia presentation to the target device.

18. The method of claim 1, wherein selecting a transformation operation is further based on user preferences.

19. The method of claim 1 further comprising:
delivering the adapted version of the multimedia presentation to the target device.

20. The method of claim 1 further comprising:
receiving at least one of a source version of media data, composition data, and description data for the source version of the multimedia presentation.

21. A machine-readable medium having instructions to cause a machine to perform a method comprising:
selecting a transformation operation from a plurality of transformation operations based on capabilities of a target device; and
creating an adapted version of a multimedia presentation for the target device from a source version of the multimedia presentation using the selected transformation operation, the adapted version of the multimedia presentation comprising adapted media data corresponding to a source version of media data for the multimedia presentation.

22. The machine-readable medium of claim 21, wherein creating an adapted version comprises:
transforming a source version of description data for the multimedia presentation into a target version of the description data; and
generating the adapted media data from the target version of the description data.

23. The machine-readable medium of claim 21, wherein creating an adapted version comprises:
deriving the source version of the media data from a source version of description data for the multimedia presentation; and
transforming the source version of the media data into the adapted media data.

24. The machine-readable medium of claim 21, wherein creating an adapted version comprises:
preparing an adapted media object for each of a plurality of media objects in the source version of the media data.

25. The machine-readable medium of claim 21, wherein creating an adapted version comprises:
adapting at least one of a spatial resolution and a temporal resolution if the source version of the media data includes at least one of video data and image data.

26. The machine-readable medium of claim 21, wherein creating an adapted version comprises:
adapting a bit rate of the source version of the media data according to a desired bit rate.

27. The machine-readable medium of claim 26, wherein the desired bit rate is based at least one of user preferences, transmission medium bandwidth, and target device capabilities.

28. The machine-readable medium of claim 21, wherein creating an adapted version comprises:
generating a summarized form of the source version of the media data.

29. The machine-readable medium of claim 21, wherein the adapted version of the multimedia presentation further comprises adapted composition data.

30. The machine-readable medium of claim 29, wherein creating an adapted version comprises:
generating the adapted composition data based on the capabilities of the target device and properties of the adapted media data corresponding to a source version of composition data for the multimedia presentation.

31. The machine-readable medium of claim 29, wherein creating an adapted version comprises:
transforming a source version of description data for the multimedia presentation into a target version of the description data; and
generating the adapted composition data from the target version of the description data.

32. The machine-readable medium of claim 29, wherein creating an adapted version comprises:
deriving the source version of the composition data from a source version of description data for the multimedia presentation; and
transforming the source version of the composition data into the adapted composition data.

33. The machine-readable medium of claim 29, wherein the adapted composition data comprises spatial and temporal layout, and synchronization information for a plurality of media objects in the adapted media data.

34. The machine-readable medium of claim 29, wherein the source version of the multimedia presentation further comprises the source version of the composition data.

35. The machine-readable medium of claim 21, wherein selecting a transformation operation comprises sequencing selected transformation operations to meet optimization criteria.

36. The machine-readable medium of claim 21, wherein the transformation operation is selected according to a set of rules.

37. The machine-readable medium of claim 21, wherein the capabilities of the target device include properties of a medium for delivering the adapted multimedia presentation to the target device.

38. The machine-readable medium of claim 21, wherein selecting a transformation operation is further based on user preferences.

39. The machine-readable medium of claim 21, wherein the method further comprises:
delivering the adapted version of the multimedia presentation to the target device.

40. The machine-readable medium of claim 21, wherein the method further comprises:
receiving at least one of a source version of media data, composition data, and description data for the source version of the multimedia presentation.

41. A system comprising:
a processor coupled to a memory through a bus;
a transformation process executed by the processor from the memory to cause the processor to select a transformation operation from a plurality of transformation operations based on capabilities of a target device, and create an adapted version of a multimedia presentation for the target device from a source version of the multimedia presentation using the selected transformation operation, the adapted version of the multimedia presentation comprising adapted media data corresponding to a source version of media data for the multimedia presentation.

42. The system of claim 21, wherein the transformation process further causes the processor, when creating an adapted version, to transform a source version of description data for the multimedia presentation into a target version of the description data, and generate the adapted media data from the target version of the description data.

43. The system of claim 21, wherein the transformation process further causes the processor, when creating an adapted version, to derive the source version of the media data from a source version of description data for the multimedia presentation, and transform the source version of the media data into the adapted media data.

44. The system of claim 21, wherein the transformation process further causes the processor, when creating an adapted version, to preparing an adapted media object for each of a plurality of media objects in the source version of the media data.

45. The system of claim 21, wherein the transformation process further causes the processor, when creating an adapted version, to adapt at least one of a spatial resolution and a temporal resolution if the source version of the media data includes at least one of video data and image data.

46. The system of claim 21, wherein the transformation process further causes the processor, when creating an adapted version, to adapt a bit rate of the source version of the media data according to a desired bit rate.

47. The system of claim 46, wherein the desired bit rate is based at least one of user preferences, transmission medium bandwidth, and target device capabilities.

48. The system of claim 41, wherein the transformation process further causes the processor, when creating an adapted version, to generate a summarized form of the source version of the media data.

49. The system of claim 41, wherein the adapted version of the multimedia presentation further comprises adapted composition data corresponding to a source version of composition data for the multimedia presentation.

50. The system of claim 49, wherein the transformation process further causes the processor, when creating an adapted version, to generate the adapted composition data based on the capabilities of the target device and properties of the adapted media data.

51. The system of claim 49, wherein the transformation process further causes the processor, when creating an adapted version, to transform a source version of description data for the multimedia presentation into a target version of the description data, and generate the adapted composition data from the target version of the description data.

52. The system of claim 49, wherein the transformation process further causes the processor, when creating an adapted version, to derive the source version of the composition data from a source version of description data for the multimedia presentation, and transform the source version of the composition data into the adapted composition data.

53. The system of claim 49, wherein the adapted composition data comprises spatial and temporal layout, and synchronization information for a plurality of media objects in the adapted media data.

54. The system of claim 49, wherein the source version of the multimedia presentation further comprises the source version of the composition data.

55. The system of claim 41, wherein the transformation process further causes the processor, when selecting a transformation operation, to sequence selected transformation operations to meet optimization criteria.

56. The system of claim 41, wherein the transformation operation is selected according to a set of rules.

57. The system of claim 41, wherein the capabilities of the target device include properties of a medium for delivering the adapted multimedia presentation to the target device.

58. The system of claim 41, wherein the transformation process further causes the processor to base the selection of a transformation operation on user preferences.

59. The system of claim 41 further comprising an interface coupled to the processor through the bus, and wherein the transformation process further causes the processor to deliver the adapted version of the multimedia presentation to the target device through the interface.

60. The system of claim 41 further comprising an interface coupled to the processor through the bus, and wherein the transformation process further causes the processor to receive at least one of a source version of media data, composition data, and description data for the source version of the multimedia presentation through the interface.

61. An apparatus comprising:
means for selecting a transformation operation from a plurality of transformation operations based on capabilities of a target device; and
means for creating an adapted version of a multimedia presentation for the target device from a source version of the multimedia presentation using the selected transformation operation, the adapted version of the multimedia presentation comprising adapted media data corresponding to a source version of media data for the multimedia presentation.

62. The apparatus of claim 61, wherein the means for creating comprises:
means for transforming a source version of description data for the multimedia presentation into a target version of the description data; and
means for generating the adapted media data from the target version of the description data.

63. The apparatus of claim 61, wherein the means for creating comprises:
means for deriving the source version of the media data from a source version of description data for the multimedia presentation; and
means for transforming the source version of the media data into the adapted media data.

64. The apparatus of claim 61, wherein the adapted version of the multimedia presentation further comprises adapted composition data corresponding to a source version of composition data for the multimedia presentation.

65. The apparatus of claim 64, wherein the means for creating comprises:
means for generating the adapted composition data based on the capabilities of the target device and properties of the adapted media data.

66. The apparatus of claim 64, wherein the means for creating comprises:
means for transforming a source version of description data for the multimedia presentation into a target version of the description data; and
means for generating the adapted composition data from the target version of the description data.

67. The apparatus of claim 64, wherein the means for creating comprises:
means for deriving the source version of the composition data from a source version of description data for the multimedia presentation; and
means for transforming the source version of the composition data into the adapted composition data.

68. The apparatus of claim 64, wherein the source version of the multimedia presentation further comprises the source version of the composition data.

69. The apparatus of claim 61 further comprises means for delivering the adapted version of the multimedia presentation to the target device.

70. The apparatus of claim 61 further comprises means for receiving at least one of a source version of media data, composition data, and description data for the source version of the multimedia presentation.
